(19) United States
(12) Patent Application Publication
(10) Pub. No.: US 2025/0341664 A1
(43) Pub. Date: Nov. 6, 2025

(54) OPTICAL ASSEMBLY AND CAMERA MODULE

(71) Applicant: SAMSUNG ELECTRONICS CO., LTD., Suwon-si (KR)

(72) Inventors: Minook Kim, Suwon-si (KR); Kiwoo LEE, Suwon-si (KR); Jinmyoung Mok, Suwon-si (KR); Younggyu Jung, Suwon-si (KR)

(73) Assignee: SAMSUNG ELECTRONICS CO., LTD., Suwon-si (KR)

(21) Appl. No.: 19/191,519

(22) Filed: Apr. 28, 2025

(30) Foreign Application Priority Data
May 3, 2024 (KR) 10-2024-0059404
Aug. 13, 2024 (KR) 10-2024-0108494

(51) Int. Cl. G02B 5/22; G02B 5/20; G02B 13/00; G03B 17/17; G03B 30/00; H04N 23/55; H04N 23/57

(52) U.S. Cl. CPC G02B 5/226; G02B 5/208; G02B 13/0065; G03B 17/17; G03B 30/00; H04N 23/55; H04N 23/57

(57) ABSTRACT

Provided is an optical assembly and camera module including same, the optical assembly including: a first reflective member configured to reflect light, received in a first direction, in a second direction intersecting the first direction; a second reflective member configured to reflect the light reflected by the first reflective member in a third direction and onto an image sensor, wherein the third direction intersects the second direction; and a first lens group between the first reflective member and the second reflective member in the second direction, the first lens group comprising at least one lens, wherein at least a portion of at least one of the first reflective member and the second reflective member comprises an infrared cut material configured to absorb at least a portion of an infrared portion of the light.

### CROSS-REFERENCE TO RELATED APPLICATION

This application is based on and claims priority to Korean Patent Application No. 10-2024-0059404, filed on May 3, 2024, and 10-2024-0108494, filed on Aug. 13, 2024, in the Korean Intellectual Property Office, the disclosures of which are incorporated by reference herein in their entireties.

### BACKGROUND

The disclosure relates to an optical assembly and a camera module, and more specifically, to an optical assembly and a camera module that absorbs at least a portion of infrared light among incident light.

In a miniaturized electronic device including a plurality of camera modules, a folded optics camera may be useful for expanding or enlarging a focal length. For example, in a folded camera, because a reflective member such as a prism is arranged, the design or arrangement of a direction in which lenses are arranged may be freely determined regardless of the direction in which external light is incident, and thus, the focal length may be expanded. As the degree of design freedom for the arrangement direction of the lenses in a folded camera is improved, a miniaturized telephoto camera may be implemented and may be mounted on an electronic device in combination with a wide-angle camera. If a folded camera is embedded in an electronic device, the total length of the folded camera may be increased due to the arrangement of an image sensor and an infrared cut filter in the folded camera, and some portions of the folded camera may protrude outside the electronic device. This may reduce user convenience and reduce the aesthetic sensibility of the electronic device's appearance.

Accordingly, technology to reduce the protruding portion of the electronic device of the folded camera is required.

### SUMMARY

Provided is an optical assembly and a camera module with a reduced overall length that includes an infrared cut function without including a separate infrared cut filter.

According to an aspect of the disclosure, an optical assembly includes: a first reflective member configured to reflect light, received in a first direction, in a second direction intersecting the first direction; a second reflective member configured to reflect the light reflected by the first reflective member in a third direction and onto an image sensor, wherein the third direction intersects the second direction; and a first lens group between the first reflective member and the second reflective member in the second direction, the first lens group comprising at least one lens, wherein at least a portion of at least one of the first reflective member and the second reflective member comprises an infrared cut material configured to absorb at least a portion of an infrared portion of the light.

According to an aspect of the disclosure, a camera module includes: a first reflective member configured to reflect light, received in a first direction, in a second direction perpendicular to the first direction; a second reflective member configured to reflect the light reflected by the first reflective member in a third direction perpendicular to the second direction; and an image sensor configured to convert into an electrical signal the light reflected by the second reflective member, wherein the image sensor comprises an infrared filter configured to absorb at least a portion of an infrared portion of the light.

According to an aspect of the disclosure, a camera module includes: a first reflective member configured to reflect light, received in a first direction, in a second direction perpendicular to the first direction; a second reflective member configured to reflect the light reflected by the first reflective member in a third direction perpendicular to the second direction; and an image sensor configured to convert into an electrical signal the light reflected by the second reflective member, wherein at least one of the first reflective member and the second reflective member uniformly comprises an infrared cut material, and wherein the infrared cut material is configured to absorb at least a portion of an infrared portion of the light.

### BRIEF DESCRIPTION OF DRAWINGS

The above and other aspects and features of certain embodiments of the present disclosure will be more apparent from the following detailed description taken in conjunction with the accompanying drawings, in which:

FIG. 1 is a block diagram illustrating a camera module according to one or more embodiments;

FIG. 2A is a plan view illustrating a prism according to one or more embodiments;

FIG. 2B is a perspective view illustrating a prism according to one or more embodiments;

FIG. 3 is a plan view illustrating an infrared prism according to one or more embodiments;

FIG. 4 is a diagram illustrating a camera module according to one or more embodiments;

FIG. 5 is a diagram to explain a camera module including an infrared prism according to one or more embodiments;

FIG. 6 is a diagram to explain a first reflective member and a second reflective member according to one or more embodiments;

FIG. 7 is a diagram to explain a camera module including a coating layer according to one or more embodiments;

FIG. 8 is a diagram to explain a camera module according to one or more embodiments;

FIG. 9 is a diagram illustrating a camera module including an image sensor according to one or more embodiments;

FIG. 10 is a diagram to explain an image sensor including an infrared filter according to one or more embodiments;

FIG. 11 is a diagram illustrating a camera module including an on-chip infrared filter image sensor according to one or more embodiments;

FIG. 12 is a diagram illustrating a camera module including an on-chip infrared

filter image sensor according to one or more embodiments;

FIG. 13 is a diagram to explain a camera module including a coating layer according to one or more embodiments;

FIG. 14 is a diagram to explain a camera module including an infrared prism and a coating layer according to one or more embodiments;

FIG. 15 is a front perspective view of an electronic device according to one or more embodiments;

FIG. 16 is a rear perspective view of an electronic device according to one or more embodiments; and

FIG. 17 is a block diagram illustrating an electronic device according to one or more embodiments.

### DETAILED DESCRIPTION

Hereinafter, embodiments of the disclosure will be described in detail with reference to the accompanying drawings. In the drawings, like reference numbers refer to like elements and the descriptions thereof will not be repeated. Sizes of elements in the drawings may be exaggerated for clarity and convenience of explanation.

It will be understood that when an element or layer is referred to as being “on” or “above” another element or layer, the element or layer may be directly on another element or layer or intervening elements or layers.

Although the terms “first”, “second”, etc., may be used herein to describe various elements, these terms are only used to distinguish one element from another. These terms do not limit the material or structure of the components.

The singular forms are intended to include the plural forms as well, unless the context clearly indicates otherwise. When a part “comprises” or “includes” an element in the specification, unless otherwise defined, other elements are not excluded from the part and the part may further include other elements.

As used herein, the expressions “at least one of a, b or c” and “at least one of a, b and c” indicate “only a,” “only b,” “only c,” “both a and b,” “both a and c,” “both b and c,” and “all of a, b, and c.”

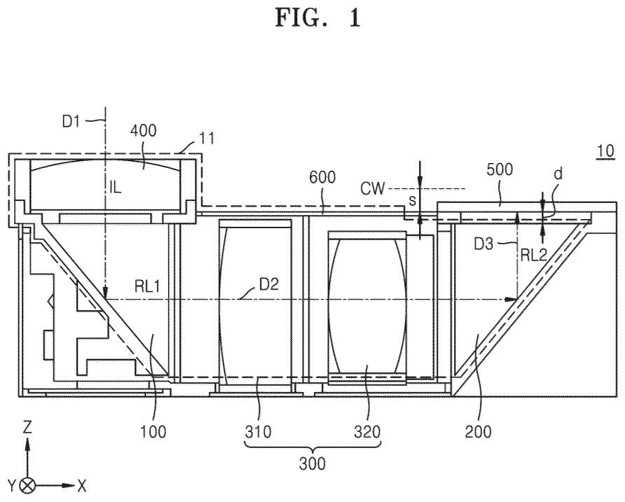

FIG. 1 is a block diagram showing a camera module 10 according to one or more embodiments.

Referring to FIG. 1, the camera module 10 may include an optical assembly 11 and an image sensor 500. The optical assembly 11 may include a first reflective member 100, a second reflective member 200, a first lens group 300, and a second lens group 400. However, the disclosure is not necessarily limited thereto, and some components of the optical assembly 11 may be omitted or other components may be further added thereto as needed.

The camera module 10 may be mounted on an electronic device having an image or light sensing function. For example, the camera module 10 may be implemented as a personal computer (PC), an Internet of Things (IoT) device, or a portable electronic device. The portable electronic devices may include laptop computers, mobile phones, smartphones, tablet PCs, personal digital assistants (PDAs), enterprise digital assistants (EDAs), digital still cameras, digital video cameras, audio devices, portable multimedia players (PMPs), personal navigation devices (PNDs), MP3 players, handheld game consoles, e-books, wearable devices, etc. In addition, the camera module 10 may be mounted on electronic devices such as drones, Advanced Drivers Assistance Systems (ADAS), etc., or electronic devices provided as components in vehicles, furniture, manufacturing equipment, doors, various measuring devices, etc.

In the embodiment, the optical assembly 11 may have a folded structure. For example, the optical assembly 11 may have a double folded structure. For example, in the double folded structure, light received by (i.e., incident on) the optical assembly 11 may be reflected twice, and the double folded structure may include two or more reflective members. The optical assembly 11 may include the first reflective member 100 and the second reflective member 200, and light received by the optical assembly 11 may be reflected twice.

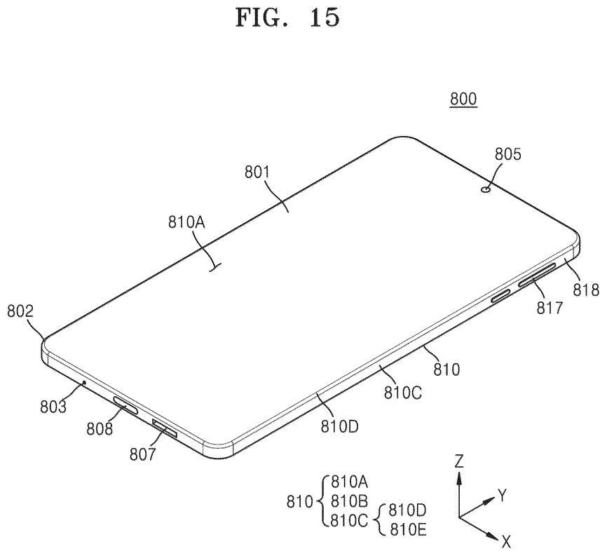

The second lens group 400 may include at least one lens. The second lens group 400 may focus light received by the camera module 10 onto the first reflective member 100 (as used herein, the expression “light received” is used interchangeably with “incident light”, “light incident on”, and “incident light IL”). The incident light IL may include visible light and infrared light. For example, the second lens group 400 may change a light path so that the incident light IL is incident perpendicularly to an incident surface of the first reflective member 100. The incident light IL may be incident in a first direction D1. Here, the first direction D1 may denote, for example, a direction from which light is incident from the outside of an electronic device (e.g., an electronic device 800 of FIG. 15) or the camera module 10 when photographing an object (i.e., a “subject”). In one or more embodiments, the first direction D1 may denote a shooting direction, a subject direction, an aiming direction of the camera module 10, or a direction parallel thereto. For example, the first direction D1 may be a −Z direction. In FIG. 1, the second lens group 400 is illustrated as including one lens, but the disclosure is not necessarily limited thereto, and the second lens group 400 may include two or more lenses. For example, the second lens group 400 may include a plurality of lenses. The lenses included in the second lens group 400 may have positive refractive power or may have negative refractive power. In addition, the second lens group 400 may include a lens having positive refractive power and a lens having negative refractive power.

The second lens group 400 may include any one of a group consisting of a convex lens, a Fresnel lens, a Holographic Optical Element (HOE), a Diffraction Optical Element (DOE), a liquid crystal lens, and an optical element acting as a lens. In addition, the second lens group 400 may include a film functioning as a lens.

The second lens group 400 may be arranged on the first reflective member 100. The second lens group 400 may be arranged on the first reflective member 100 in a Z direction. The second lens group 400 and the first reflective member 100 may be positioned to be aligned in the first direction D1. According to one or more embodiments, the second lens group 400 may be omitted from the optical assembly 11. If the second lens group 400 is omitted and not disposed above the first reflective member 100, the incident light IL may be directly incident on the first reflective member 100.

The first reflective member 100 may be provided to reflect the incident light IL incident on the second lens group 400 at a predetermined angle. For example, the predetermined angle may be 90 degrees. The first reflective member 100 may reflect the incident light IL toward the first lens group 300 and the second reflective member 200. For example, the first reflective member 100 may include a prism or a mirror, and the first reflective member 100 may reflect or refract the incident light IL incident in the first direction D1 into a second direction D2 intersecting the first direction D1. The second direction D2 may be perpendicular to the first direction D1, and, for example, the second direction D2 may be an X direction.

The first reflective member 100 may reflect incident light IL received from the first direction D1 to the second direction D2, and first reflected light RL1 may be emitted. The first reflective member 100 may be arranged to be aligned with the second lens group 400 in the first direction D1 and aligned with the first lens group 300 in the second direction D2. A reflective surface of the first reflective member 100 may include a point where incident light IL received from the first direction D1 is refracted or reflected or a point where the first direction D1 and the second direction D2 intersect. An incident surface of the first reflective member 100 may face the second lens group 400 when viewed along the first direction D1, and an exit surface of the first reflective member 100 may face the first lens group 300 when viewed along the second direction D2. For example, the incident surface and the exit surface may be formed at 90 degrees relative to one another.

The first lens group 300 may include at least one lens. The first lens group 300 may focus the first reflected light RL1 emitted from the first reflective member 100 onto the second reflective member 200. The first reflected light RL1 may be incident on the first lens group 300 in the second direction D2. The first lens group 300 may include a first lens 310 and a second lens 320. Although the first lens group 300 is illustrated as including two lenses in FIG. 1, the first lens group 300 is not necessarily limited thereto, and the first lens group 300 may include three or more lenses or may include one lens.

For example, the first lens 310 may have negative refractive power and the second lens 320 may have positive refractive power. However, the disclosure is not necessarily limited thereto, and the first lens 310 may have positive refractive power, the second lens 320 may have negative refractive power, and the first lens 310 and the second lens 320 may have positive or negative refractive power.

The first lens group 300 may include any one of a group consisting of a convex lens, a Fresnel lens, an HOE, a DOE, a liquid crystal lens, and an optical element that acts as a lens. In addition, the first lens group 300 may include a film that acts as a lens. The first lens group 300 may be positioned to be aligned with the first reflective member 100 in the second direction D2. The first lens group 300 may be positioned to be aligned with the second reflective member 200 in the second direction D2.

The second reflective member 200 may reflect the first reflected light RL1 incident on the first lens group 300 at a predetermined angle. For example, the predetermined angle may be 90 degrees. The second reflective member 200 may reflect the first reflected light RL1 toward the image sensor 500. For example, the second reflective member 200 may include a prism or a mirror, and the second reflective member 200 may reflect or refract the first reflected light RL1 incident in the second direction D2 in a third direction D3 crossing the second direction. The third direction D3 may be perpendicular to the second direction D2, and the third direction D3 may be parallel to the first direction D1 or a direction opposite to the first direction D1. For example, the third direction D3 may be the Z direction.

The second reflective member 200 may reflect the first reflected light RL1 incident in the second direction D2 to the third direction D3, and second reflected light RL2 may be emitted. The second reflective member 200 may be arranged to be aligned with the first lens group 300 in the second direction D2 and aligned with the image sensor 500 in the third direction D3. A reflective surface of the second reflective member 200 may include a point where the first reflected light RL1 incident in the second direction D2 is refracted or reflected, or a point where the second direction D2 and the third direction D3 intersect. An incident surface of the second reflective member 200 may face the first lens group 300 when viewed along the second direction D2, and an exit surface of the second reflective member 200 may face the image sensor 500 when viewed along the third direction D3. The second reflected light RL2 may be incident onto (i.e., received by) the image sensor 500.

The image sensor 500 may convert the received light into an electrical signal. The image sensor 500 may generate an electrical signal based on the received second reflected light RL2. The image sensor 500 may be placed on top of the second reflective member 200 in the third direction D3.

The image sensor 500 may convert an optical signal of an object incident through the optical assembly 11 into image data. The image sensor 500 may be, for example, a charge coupled device (CCD) image sensor or a complementary metal oxide semiconductor (CMOS) image sensor.

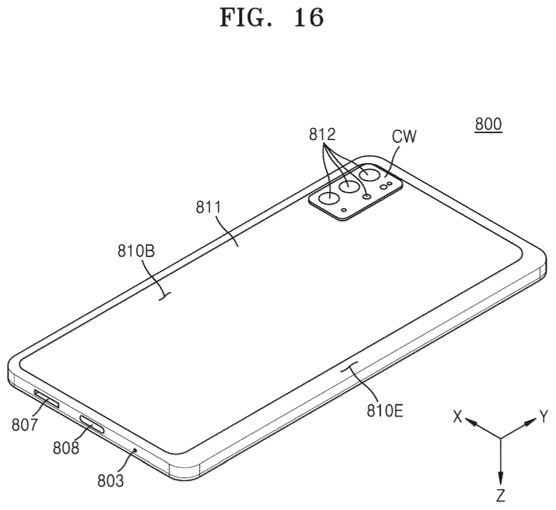

When the camera module 10 is embedded in an electronic device (for example, the electronic device 800 of FIG. 15), at least a portion of the camera module 10 may protrude outside the electronic device. The protruding portion of the camera module 10 may be covered with a cover window CW (e.g., the cover window CW of FIG. 16). For example, at least a portion of the camera module 10 may protrude from a rear of the electronic device, and the protruding portion may be covered with the cover window CW. In one or more embodiments, at least a portion of the camera module 10 may be surrounded by a housing 600, and at least a portion of the housing 600 and at least a portion of the image sensor 500 may be covered with the cover window CW. In the third direction D3, the cover window CW may be arranged on top of the image sensor 500. For example, a portion from the housing 600 to the cover window CW may protrude from the electronic device. However, the disclosure is not necessarily limited thereto, and may protrude from a portion spaced apart from the housing 600 in the third direction D3 to the cover window CW or may protrude from a distance spaced apart from the housing 600 in the first direction D1 to the cover window CW. Hereinafter, it is assumed that the protrusion is as much as a protrusion distance s from the housing 600 to the cover window CW.

Because the incident light IL includes infrared light, it is necessary to provide light from which the infrared component is removed to the image sensor 500. FIG. 1 shows the camera module 10 without an infrared cut filter. If the camera module 10 includes an infrared cut filter to block an infrared portion of the received light, the infrared ray cut filter may be placed between the second reflective member 200 and the image sensor 500. For example, the infrared cut filter may be placed in the third direction D3 between the exit surface of the second reflective member 200 and the image sensor 500. When an infrared cut filter is placed between the exit surface of the second reflective member 200 and the image sensor 500, the infrared cut filter and the image sensor 500 need to be placed at a certain distance apart to prevent bruising caused by foreign matter in the infrared cut filter. If the infrared cut filter and the image sensor 500 are arranged at a certain distance apart, a distance d from the second reflective member 200 to the image sensor 500 may further increase, and a protruding distance s may increase. That is, if the infrared cut filter is included in the camera module 10, the camera module 10 may protrude significantly from the electronic device, and a thickness of the cover window CW may increase. This may reduce user convenience and aesthetics. Therefore, it is desirable to reduce the distance d between the second reflective member 200 and the image sensor 500.

The camera module 10 according to one or more embodiments may provide an infrared cut function even without including a separate infrared cut filter, thereby reducing the distance d. In a configuration where the camera module 10 does not include an infrared cut filter positioned between the second reflective member 200 and the image sensor 500, the distance d between the second reflective member 200 and the image sensor 500 may be reduced. The distance d may denote a distance from the exit surface of the second reflective member 200 to the closest part of the image sensor 500.

In one or more embodiments, at least one of the first reflective member 100 and the second reflective member 200 may include at least a portion of an infrared cut material (e.g., an infrared cut-off filter). At least one of the first reflective member 100 and the second reflective member 200 may absorb at least a portion of infrared light. For example, the infrared cut material may include blue glass (or a blue filter) for an infrared filter.

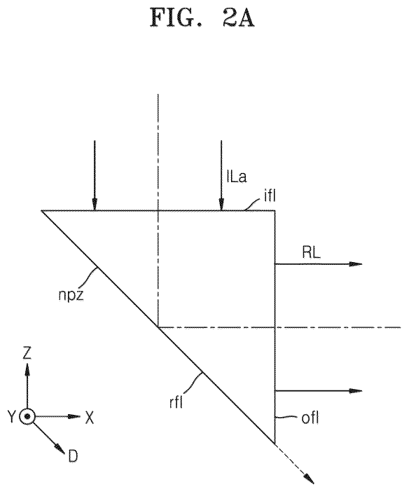

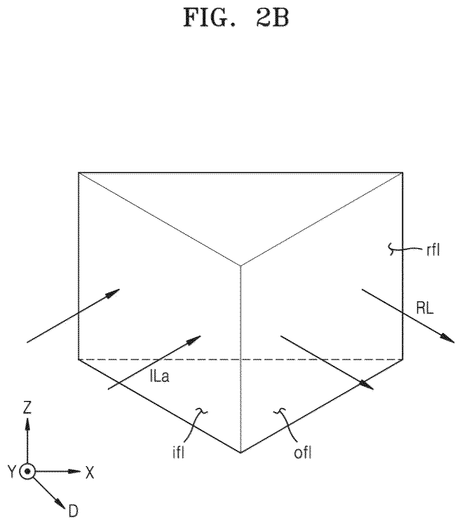

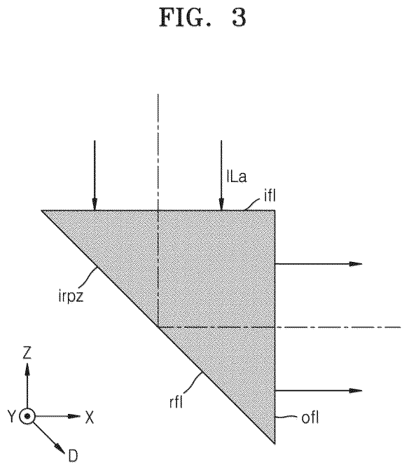

For example, at least a portion of one of the first reflective member 100 and the second reflective member 200 may include an infrared cut material. For example, the first reflective member 100 may include an infrared cut material, and the second reflective member 200 may not include an infrared ray cut material. For example, the first reflective member 100 may be an infrared prism (for example, an infrared prism irpz of FIG. 3), and the second reflective member 200 may be a normal prism (for example, a normal prism npz of FIG. 2A). In addition, the second reflective member 200 may be an infrared prism irpz, and the first reflective member 100 may be a normal prism npz. However, the disclosure is not necessarily limited thereto, and at least a portion of the first reflective member 100 and the second reflective member 200 may include an infrared cut material.

If the first reflective member 100 and the second reflective member 200 include infrared cut material, the first reflective member 100 and the second reflective member 200 may transmit visible light and block infrared light. For example, the first reflective member 100 and the second reflective member 200 including an infrared cut material may block light in at least a portion of a wavelength range from about 750 nm to about 1 mm. In the embodiment, each of the first reflective member 100 and the second reflective member 200 may include at least a portion of an infrared cut material. In one or more embodiments, the infrared wavelength range that is absorbed by the first reflective member 100 may be at least partially different from the infrared wavelength range that is absorbed by the second reflective member 200. For example, the first reflective member 100 may block light in a near-infrared wavelength range, and the second reflective member 200 may block light in an infrared wavelength range other than the near-infrared wavelength range. For example, the first reflective member 100 may block light in a wavelength range from about 750 nm to about 3000 nm, and the second reflective member 200 may block light in a wavelength range from about 3000 nm to about 1 mm. However, the disclosure is not necessarily limited thereto, and the first reflective member 100 and the second reflective member 200 may block light in various ranges within the infrared wavelength range.

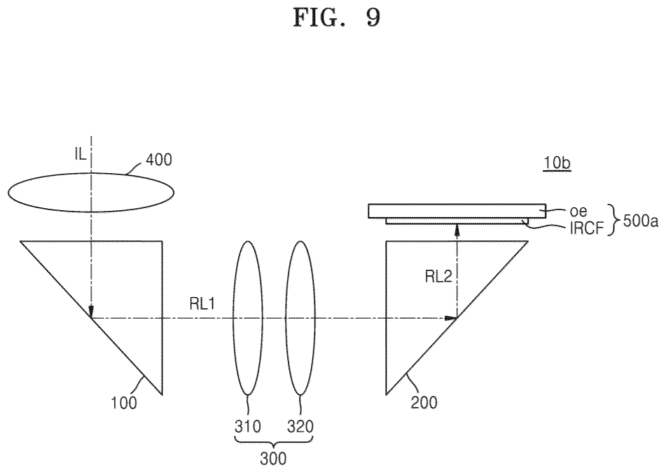

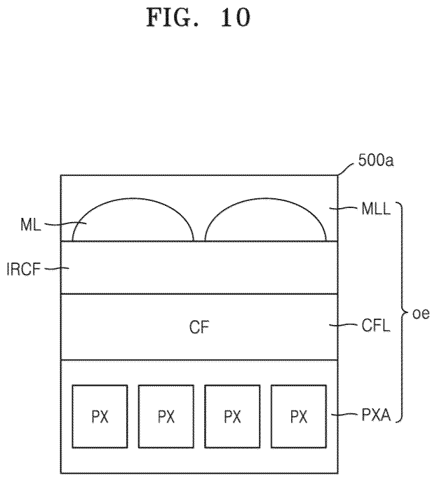

In one or more embodiments, the image sensor 500 may include an infrared filter (e.g., an infrared filter IRCF of FIG. 9) that absorbs at least a portion of infrared light. The image sensor 500 may be an on-chip infrared filter image sensor that includes an infrared filter. The infrared filter may be an infrared cut filter that transmits visible light and blocks infrared light. The infrared filter may block a wide range of light within the infrared wavelength range. The infrared filter may be positioned on top of an optical element (e.g., an optical element oe of FIG. 10) that includes a pixel array (e.g., a pixel array PXA of FIG. 10) and a color filter (e.g., a color filter CF of FIG. 10), and the optical element oe and an infrared filter IFCF may be formed integrally as the image sensor 500.

The camera module 10 according to one or more embodiments may not include an infrared cut filter, and the distance d from the second reflective member 200 to the image sensor 500 may be relatively shorter than when the infrared cut filter is arranged between the second reflective member 200 and the image sensor 500. In one or more embodiments, the distance d from the exit surface of the second reflective member 200 to the image sensor 500 may be about 0.5 mm or less. For example, the distance d may be about 0.3 mm, but the disclosure is not necessarily limited thereto.

FIG. 2A is a plan view illustrating a prism according to one or more embodiments. FIG. 2B is a perspective view illustrating a prism according to one or more embodiments. FIG. 2A illustrates a normal prism npz. A reflective member (e.g., the first reflective member 100 and the second reflective member 200 of FIG. 1) may be a prism. The normal prism npz may denote a prism that does not include an infrared cut material.

Referring to FIGS. 2A and 2B, the normal prism npz may change a path of incident light ILa and scatter the incident light. For example, the normal prism npz may be placed inside a folded optical system (e.g., the optical assembly 11 of FIG. 1) to change the path of incident light ILa through reflection. In the folded optical system, a propagation direction of the incident light ILa and a propagation direction of the reflected light RL may be approximately 90°. For example, when the first reflective member 100 of FIG. 1 is a normal prism npz, the incident light IL and the first reflected light RL1 may be the incident light ILa and the reflected light RL of FIG. 2A, respectively. If the second reflective member 200 of FIG. 1 is a normal prism npz, the first reflected light RL1 and the second reflected light RL2 may correspond to the incident light ILa and reflected light RL of FIG. 2A, respectively.

For example, the normal prism npz may have a triangular prism shape. For example, the normal prism npz may have a triangular prism shape with an isosceles triangle as a base. For example, the normal prism npz may include three faces of a square shape and two faces of a triangular shape. For example, an incident surface ifl, a reflection surface rfl, and an exit surface ofl of the normal prism npz may have a square shape, and upper and lower surfaces of the normal prism npz may have a triangular shape. For example, the normal prism npz may include a glass material.

The incident light ILa may be incident into the interior of the normal prism npz through one of the multiple faces of the normal prism npz. A surface of the normal prism npz onto which the incident light ILa is incident may correspond to the incident surface ifl. For example, the incident surface ifl of the normal prism npz may be parallel to the Z direction. Light incident in the Z direction may pass through the incident surface ifl of the normal prism npz without being refracted by the incident surface ifl.

The incident light ILa incident into the interior of the normal prism npz through the incident surface ifl may be reflected by the reflective surface rfl. If an angle formed by the reflective surface rfl and the incident surface ifl and/or the exit surface ofl is approximately 45°, the reflected light RL may be generated to move parallel to the X direction, and thus, a movement path of the reflected light RL may be controlled.

For example, the incident light ILa may include visible light and infrared light. Visible light may denote, for example, light having a wavelength of about 400 nm to about 750 nm, and infrared may denote, for example, light having a wavelength of about 750 nm to about 1 mm. A portion of the incident light ILa may be reflected from the reflective surface rfl. For example, visible light may be reflected from the reflective surface rfl and transmitted through the exit surface ofl. For example, visible light may be reflected from the reflective surface rfl and travel in the X direction. For example, at least a portion of the infrared may not be reflected from the reflective surface rfl, a portion of the infrared may travel in the D direction, and the remaining portion may be reflected from the reflective surface rfl and travel in the X direction. A portion of the infrared may be reflected from the reflective surface rfl and may be transmitted to the exit surface ofl together with the visible light, and the remaining portion of the infrared may not be transmitted to the exit surface ofl.

The reflected light RL may include visible light and infrared light reflected from the reflective surface rfl and may pass through the exit surface ofl. For example, the exit surface ofl may be substantially orthogonal to the X direction, and the reflected light RL may pass through the exit surface ofl of the normal prism npz without being refracted at the exit surface ofl of the prism. If all of the reflective members (e.g., the first reflective member 100 and the second reflective member 200 of FIG. 1) used in the camera module (e.g., the camera module 10 of FIG. 1) are normal prisms npz, the second reflected light RL2 transmitted to the image sensor (e.g., the image sensor 500 of FIG. 1) may include visible light and infrared light, and may include relatively much infrared light. That is, the reflected light RL in which a relatively high proportion of infrared light is included may be emitted from the normal prism npz.

FIG. 3 is a plan view showing an infrared prism irpz according to one or more embodiments. In FIG. 3, the infrared prism irpz is described. The reflective member (for example, the first reflective member 100 and the second reflective member 200 of FIG. 1) may be a prism. The infrared prism irpz may denote a prism including an infrared cut material. The principle of the infrared prism irpz may be similar to the normal prism npz described with reference to FIGS. 2A and 2B, thus, the descriptions thereof will not be repeated.

Referring to FIG. 3, at least a portion of the infrared prism irpz may include an infrared cut material. For example, the infrared cut material may include blue glass (or blue filter) for an infrared filter. Because the infrared prism irpz includes an infrared cut material, at least a portion of the infrared light included in the incident light IL may be absorbed. The infrared prism irpz of FIG. 3 is illustrated as being formed entirely of an infrared cut material, but the disclosure is not necessarily limited thereto, and at least a portion of the infrared prism irpz may include an infrared cut material. If the entire infrared prism irpz includes an infrared cut material, the infrared cut material may be uniformly included throughout the entire infrared prism irpz. However, the disclosure is not necessarily limited thereto, and if at least a portion of the infrared prism irpz includes an infrared cut material, the infrared cut material may be uniformly included in at least a portion of the infrared prism irpz.

Compared to the normal prism npz of FIG. 2A and FIG. 3B, because at least a portion of the infrared prism irpz includes an infrared cut material, the infrared prism irpz may have a higher infrared cut rate (i.e., filtration or cut-off rate) than the normal prism npz. That is, the infrared ray absorption rate of the infrared prism irpz may be relatively higher. At least a portion of the infrared light included in the incident light ILa may be absorbed by the infrared prism (irpz). A relatively large amount of infrared light may be absorbed by the infrared prism irpz, and the reflected light RL emitted to the exit surface ofl may include relatively little infrared light. For example, the infrared light may be completely blocked by the infrared prism irpz, and the reflected light RL may not include infrared light.

If at least one of the reflective members (e.g., the first reflective member 100 and the second reflective member 200 of FIG. 1) used in a camera module (e.g., the camera module 10 of FIG. 1) is an infrared prism irpz, the second reflected light RL2 transmitted to an image sensor (e.g., the image sensor 500 of FIG. 1) may include a relatively small amount of infrared light. That is, reflected light RL including a relatively low proportion of infrared light may be emitted from the infrared prism irpz.

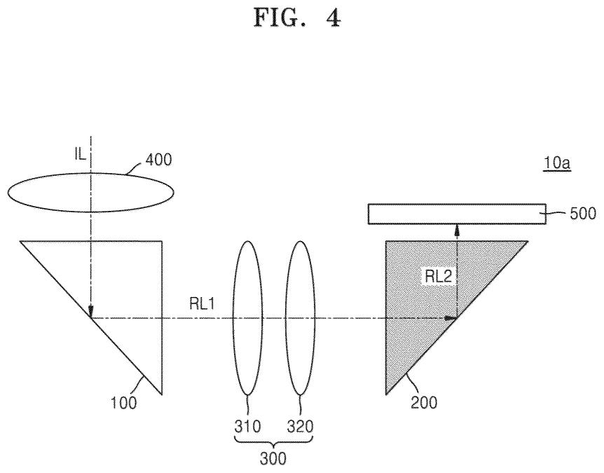

FIG. 4 is a diagram illustrating a camera module 10a according to one or more embodiments. The camera module 10a of FIG. 4 is a simplified illustration of the camera module 10 of FIG. 1. FIG. 4 shows the camera module 10a including one reflective member which is an infrared prism (for example, the infrared prism irpz of FIG. 3). Descriptions already given above are omitted.

Referring to FIG. 4, the second reflective member 200 may be an infrared prism irpz. At least one of the first reflective member 100 and the second reflective member 200 may include an infrared cut material. In one or more embodiments, one of the first reflective member 100 and the second reflective member 200 may include an infrared cut material. For example, the second reflective member 200 may be an infrared prism irpz including an infrared cut material, and the first reflective member 100 may be a normal prism (e.g., the normal prism npz of FIG. 2A) that does not include an infrared cut material. For example, the entirety of the second reflective member 200 may include an infrared cut material. That is, the entirety of the second reflective member 200 may uniformly include an infrared cut material. Consequently, the entirety of the second reflective member 200 may absorb infrared light. In FIG. 4, a case in which the second reflective member 200 is an infrared prism irpz is illustrated, but the disclosure is not necessarily limited, and the first reflective member 100 may also be an infrared prism irpz.

Because the first reflective member 100 is a normal prism npz, the first reflected light RL1 emitted from the first reflective member 100 may include visible light and a relatively large amount of infrared light. The first reflected light RL1 may be incident on the second reflective member 200. The second reflective member 200 may reflect the first reflected light RL1 and emit the first reflected light RL1 as second reflected light RL2. Because the second reflective member 200 is an infrared prism irpz, the second reflective member 200 may absorb at least a portion of the infrared portion from among the visible light and infrared light included in the first reflected light RL1. Because the second reflective member 200 absorbs infrared light, the second reflected light RL2 may include visible light and a relatively small amount of infrared light. For example, the second reflected light RL2 may include only visible light.

The second reflected light RL2 may be transmitted to the image sensor 500. The image sensor 500 may generate an electrical signal based on the second reflected light RL2 that includes a relatively small amount of infrared light or no infrared light. The image sensor 500 may detect light in which infrared light is substantially blocked. In one or more embodiments, the image sensor 500 may be an image sensor that does not include an infrared filter. Because the second reflected light RL2 with a relatively small or no infrared light is incident on the image sensor 500, a separate infrared cut filter may be omitted from the camera module 10a. Because the infrared cut filter is not arranged between the second reflective member 200 and the image sensor 500, a required separation distance between the infrared cut filter and the image sensor 500 may be reduced. Accordingly, a distance from the second reflective member 200 to the image sensor 500 (for example, the distance d in FIG. 1) may be reduced, and because the protruding portion of the camera module 10a in the electronic device is also reduced, user convenience and aesthetics may be improved.

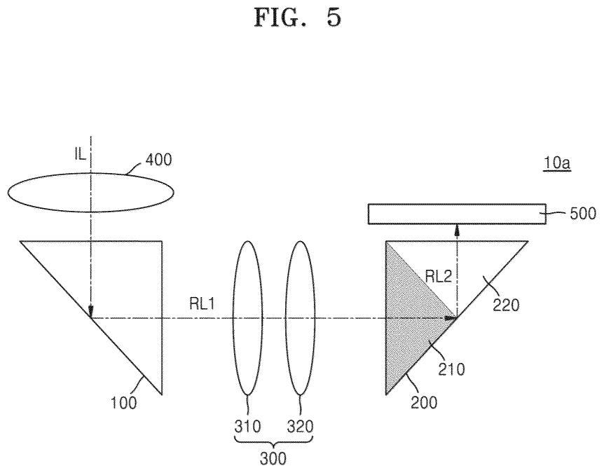

FIG. 5 is a diagram illustrating a camera module including an infrared prism according to one or more embodiments. FIG. 5 shows one or more embodiments in which a portion of one reflective member includes an infrared material. Descriptions already given with reference to FIG. 4 will be omitted.

Referring to FIG. 5, the second reflective member 200 may be an infrared prism irpz. In one or more embodiments, a portion of one of the first reflective member 100 and the second reflective member 200 may include an infrared cut material. For example, the second reflective member 200 may be an infrared prism irpz including an infrared cut material, and the first reflective member 100 may be a normal prism (for example, the normal prism npz of FIG. 2A) that does not include an infrared cut material. For example, a portion of the second reflective member 200 may include an infrared cut material. The second reflective member 200 may include an infrared region 210 and a normal region 220. The infrared region 210 may denote a portion including an infrared cut material, and the normal region 220 may denote a portion that does not include an infrared cut material. The entire infrared region 210 may uniformly include an infrared cut material, and infrared light may be absorbed throughout the entire infrared region 210. In one or more embodiments, the infrared region 210 and the normal region 220 may be formed as one prism.

Because the second reflective member 200 is an infrared prism irpz, the second reflective member 200 may absorb infrared light among visible light and infrared light included in the first reflected light RL1. The infrared region 210 of the second reflective member 200 may absorb infrared light, and the second reflected light RL2 may include visible light and a relatively small amount of infrared light or may include only visible light. The second reflected light RL2 may be transmitted to the image sensor 500.

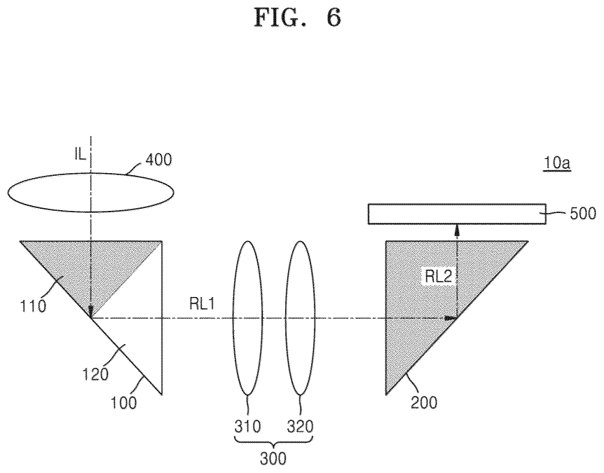

FIG. 6 is a diagram illustrating a first reflective member 100 and a second reflective member 200 according to one or more embodiments. FIG. 6 shows an embodiment in which the first reflective member 100 and the second reflective member 200 are infrared prisms irpz. Descriptions already given above are omitted.

Referring to FIG. 6, the first reflective member 100 and the second reflective member 200 may be infrared prisms irpz. Both the first reflective member 100 and the second reflective member 200 may be infrared prisms irpz. In one or more embodiments, at least one of the first reflective member 100 and the second reflective member 200 may include entirely an infrared cut material, and the other may partially include an infrared cut material. For example, a portion of the first reflective member 100 may partially include an infrared cut material, and the second reflective member 200 may entirely include an infrared cut material. The first reflective member 100 may include an infrared region 110 and a normal region 120.

In one or more embodiments, an infrared wavelength range absorbed by the first reflective member 100 may be at least partially different from an infrared wavelength range absorbed by the second reflective member 200. For example, the first reflective member 100 may block light in a near-infrared wavelength range, and the second reflective member 200 may block light in an infrared wavelength range other than a near-infrared wavelength range.

The first reflective member 100 may absorb infrared light included in the incident light IL, and the second reflective member 200 may also absorb infrared light. Because the first reflective member 100 and the second reflective member 200 are infrared prisms irpz, the camera module 10a may block more infrared light. In FIG. 6, an embodiment in which a part of the first reflective member 100 includes an infrared cut material, and the entirety of the second reflective member 200 includes an infrared cut material is illustrated. However, the disclosure is not necessarily limited thereto, and a part of the second reflective member 200 may include an infrared cut material, and the entirety of the first reflective member 100 may include an infrared cut material. In addition, both the first reflective member 100 and the second reflective member 200 may be infrared prisms irpz including entirely an infrared cut material.

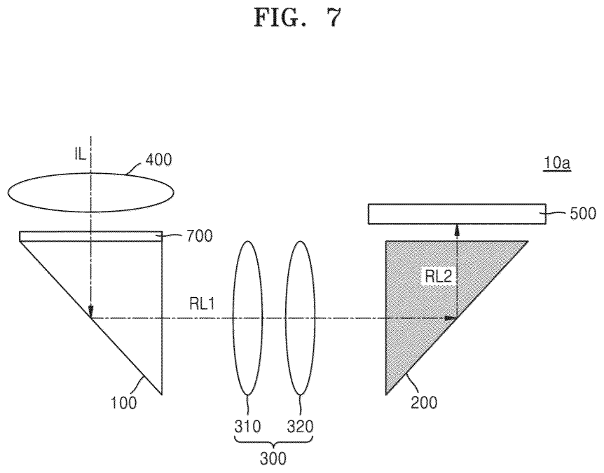

FIG. 7 is a diagram illustrating the camera module 10a including a coating layer 700 according to one or more embodiments. FIG. 7 shows an embodiment in which the coating layer 700 is arranged on the outside of the first reflective member 100. In FIG. 7, it is assumed that the second reflective member 200 is an infrared prism irpz, the first reflective member 100 is a normal prism npz, and the coating layer 700 is arranged adjacent to the first reflective member 100. Descriptions already given above are omitted.

Referring to FIG. 7, the coating layer 700 may be arranged on the outside of the first reflective member 100. In one or more embodiments, at least one of the first reflective member 100 and the second reflective member 200 of the camera module 10a may be an infrared prism irpz, and the camera module 10a may include a coating layer disposed on the outside of at least one of the first reflective member 100 and the second reflective member 200. For example, the second reflective member 200 may be an infrared prism irpz, and the coating layer 700 may be disposed on the outside of the first reflective member 100. However, the disclosure is not necessarily limited thereto, and the coating layer 700 may be disposed on the outside of the second reflective member 200, or may be disposed on the outside of each of the first reflective member 100 and the second reflective member 200. In addition, the same may be applied when at least one of the first reflective member 100 and the second reflective member 200 include entirely an infrared cut material or a portion of the first reflective member 100 and the second reflective member 200 include an infrared cut material.

The coating layer 700 may absorb at least a portion of infrared light included in the incident light IL. The coating layer 700 may absorb the infrared light incident to the coating layer 700. At least one of surfaces of the reflective members (e.g., first and second reflective members 100 and 200) may be coated with an infrared cut material, and the coating layer 700 may be formed. For example, the infrared cut material may be coated on one surface of the manufactured prism (normal prism npz or infrared prism irpz) to form the coating layer 700.

In one or more embodiments, the coating layer 700 may be arranged to contact at least one of the incident surface and the exit surface of at least one of the reflective members. For example, the coating layer 700 may be arranged to contact the incident surface of the first reflective member 100. The infrared cut material may be coated on the incident surface of the first reflective member 100. However, the disclosure is not necessarily limited thereto, and the coating layer 700 may be arranged to contact the exit surface of the first reflective member 100. The camera module 10a may have improved infrared cut performance by including at least one infrared prism and the coating layer 700.

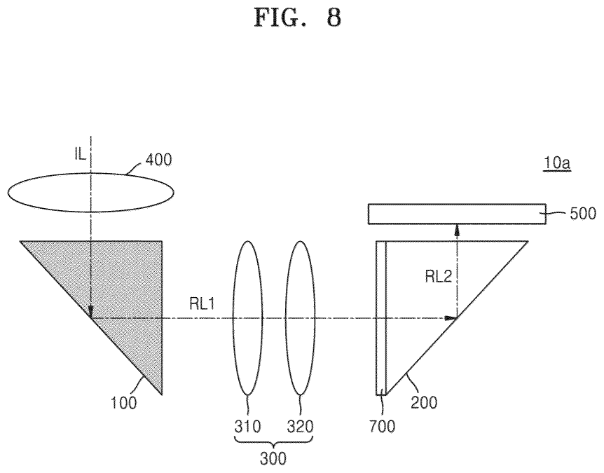

FIG. 8 is a diagram to explain the camera module 10a according to one or more embodiments. FIG. 8 shows an example in which the coating layer 700 is arranged on the outside of the second reflective member 200. In FIG. 8, it is assumed that the first reflective member 100 is an infrared prism irpz, the second reflective member 200 is a normal prism npz, and the coating layer 700 is arranged adjacent to the second reflective member 200. Descriptions already given above are omitted.

Referring to FIG. 8, the first reflective member 100 may be an infrared prism irpz, and the coating layer 700 may be arranged on the outside of the second reflective member 200. However, the disclosure is not necessarily limited thereto. For example, the coating layer 700 may be arranged to contact the incident surface of the second reflective member 200. An infrared cut material may be coated on the incident surface of the second reflective member 200. However, the disclosure is not necessarily limited thereto, and the coating layer 700 may be arranged to contact the exit surface of the second reflective member 200.

FIG. 9 is a diagram showing a camera module 10b including an image sensor 500a according to one or more embodiments. In FIG. 9, it is assumed that the first reflective member 100 and the second reflective member 200 are normal prisms (for example, the normal prism npz of FIG. 2A). However, the disclosure is not necessarily limited thereto, and the description of FIG. 9 may also be applied when at least one of the first reflective member 100 and the second reflective member 200 is an infrared prism (for example, the infrared prism irpz of FIG. 3).

Referring to FIG. 9, the camera module 10b may include the image sensor 500a. The image sensor 500a may include an infrared filter IRCF that blocks infrared light. The infrared filter IRCF may absorb at least a portion of infrared light included in the incident light IL. The image sensor 500a may be an on-chip infrared filter image sensor including an infrared filter. The on-chip infrared filter image sensor 500a may be different from an infrared cut filter separately arranged between the second reflective member 200 and the image sensor 500a. The on-chip infrared filter image sensor 500a may be formed integrally with an optical element oe and the infrared filter IRCF as one image sensor. That is, because the image sensor 500a includes the infrared filter IRCF, a separate infrared cut filter may not be arranged in the camera module 10b.

The infrared filter IRCF may be an infrared cut filter that transmits visible light and blocks infrared light. The infrared filter IRCF may block a wide range of light within the infrared wavelength range. The infrared filter IRCF may be placed on top of the optical element oe including a pixel array (e.g., a pixel array PXA of FIG. 10) and a color filter layer (e.g., a color filter layer CFL of FIG. 10), and the optical element oe and the infrared filter IRCF may be formed as an integral image sensor 500a. The structure of the image sensor 500a will be described in detail below with reference to FIG. 10.

The image sensor 500a may be mounted on a printed circuit board (PCB) of the camera module 10b. In one or more embodiments, the image sensor 500a may be mounted on a PCB by a wire bonding method using wires.

If the first reflective member 100 and the second reflective member 200 are normal prisms npz, second reflected light RL2 incident on the image sensor 500a may include a relatively large amount of infrared light. Because the image sensor 500a includes an infrared filter IRCF, even if infrared light is incident on the image sensor 500a, the infrared light may be cut by the infrared filter IRCF. Because infrared light is absorbed by the infrared filter IRCF of the image sensor 500a, a separate infrared cut filter may be omitted from the camera module 10b. Because a separate infrared cut filter is not arranged, a required separation distance between the infrared cut filter and the image sensor 500 may be reduced. Accordingly, the distance from the second reflective member 200 to the image sensor 500 (for example, the distance d in FIG. 1) may be reduced, and the protruding portion of the camera module 10b in the electronic device may also be reduced, thereby improving user convenience and aesthetics.

FIG. 10 is a diagram to explain the image sensor 500a including an infrared filter according to one or more embodiments. Descriptions already given with reference to FIG. 9 are omitted. Hereinafter, FIG. 9 and FIG. 10 are referred to together.

The image sensor 500a may include the optical element oe and the infrared filter IRCF. The optical element oe may include a pixel array PXA, a color filter layer CFL, and a micro lens layer MLL. However, the disclosure is not necessarily limited thereto, and other components may be added thereto as needed, and the micro lens layer MLL may be omitted therefrom. The micro lens layer MLL may not be included in the optical element oe. In one or more embodiments, the optical element oe and the infrared filter IRCF may be formed as an integral body to form the image sensor 500a.

The image sensor 500a may convert an optical signal of an object incident on (i.e., received through) an optical assembly (e.g., the optical assembly 11 of FIG. 1) into image data. The image sensor 500a may be, for example, a CCD image sensor or a CMOS image sensor.

The image sensor 500a may convert the second reflected light RL2 incident through the second reflective member 200 into an electrical signal. The second reflected light RL2 may be transmitted to the infrared filter IRCF and the optical element oe. Visible light included in the second reflected light RL2 may pass through the infrared filter IRCF, and infrared light included in the second reflected light RL2 may be absorbed by the infrared filter IRCF.

The optical element oe converts an optical image of an object formed by the infrared filter IRCF into an electrical signal. The optical element oe may include the micro lens layer MLL, the color filter layer CFL, and the pixel array PXA.

The pixel array PXA may include a plurality of pixels PX. Each of the plurality of pixels PX may detect light of a specific spectral range from light received through the micro lens layer MLL. The pixel array PXA includes a plurality of pixels PX connected to a plurality of row lines, a plurality of column lines, and a plurality of row lines and a plurality of column lines and arranged in a matrix. In one or more embodiments, the plurality of pixels PX may be active pixel sensors APS. The pixel array PXA may include a plurality of pixels PX that detect light of different wavelengths. The arrangement of the plurality of pixels PX may be implemented in various ways.

Each of the plurality of pixels PX may include at least one photoelectric conversion element, and the pixel PX may detect light using the photoelectric conversion element and output an image signal, which is an electrical signal according to the detected light. For example, the photoelectric conversion element may be a light-sensing element including an organic material or an inorganic material, such as an inorganic photodiode, an organic photodiode, a perovskite photodiode, a phototransistor, a photo gate, or a pinned photodiode. In one or more embodiments, each of the plurality of pixels PX may include a plurality of photoelectric conversion elements.

The color filter layer CFL may include a color filter CF. The color filter layer CFL can be arranged on the upper part of the pixel array PXA. A color filter CF may transmit light in a specific spectrum region. The color filter CF may transmit light in a visible ray range Depending on the type of color filter CF arranged on top of each of a plurality of pixels PX, the type of light that may be detected by the corresponding pixel PX may be determined.

If a color filter CF for transmitting light in a visible ray region is arranged on top of a specific pixel PX in the pixel array PXA, the corresponding pixel PX may detect light in the visible ray region and convert the light in the visible ray region into an electrical signal. A color that the corresponding pixel PX may detect may be determined depending on the color filter CF arranged on top of the specific pixel PX. However, the disclosure is not limited thereto, and in the case of a specific photodiode, light in a specific wavelength band may be converted into an electrical signal depending on the level of an electrical signal applied to the photoelectric conversion element.

The color filter CF may include a red color filter, a green color filter, and a blue color filter. However, the color filter CF is not limited thereto, and may include color filters CF that transmit light in other spectral regions than red, green, and blue. For example, the color filter CF may include color filters CF for sensing yellow, cyan, and magenta colors.

In one or more embodiments, the infrared filter IRCF may be disposed on top of the color filter layer CFL. The infrared filter IRCF may be disposed on top of the color filter layer CFL in a direction from the pixel array PXA toward the color filter layer CFL. For example, the infrared filter IRCF may be disposed between the color filter layer CFL and the micro lens layer MLL. However, the disclosure is not necessarily limited thereto.

In one or more embodiments, the infrared filter IRCF may include a plurality of filter layers. The infrared filter IRCF may include a first filter layer and a second filter layer. The first filter layer may be a material layer having a first refractive index, and the second filter layer may be a material layer having a second refractive index. The first refractive index may be different from the second refractive index. For example, the first refractive index may be greater than the second refractive index. However, the disclosure is not necessarily limited thereto, and the first refractive index may be less than the second refractive index.

For example, the infrared filter IRCF may have a structure in which the first filter layer and the second filter layer are alternately stacked. For example, SiN, Si, TiO, GaAs, GaP, GaN, etc. may be used as the first filter layer, and SiO₂, SOG, SU-8, etc. may be used as the second filter layer. However, the disclosure is not necessarily limited thereto. A thickness of each of the first filter layer and the second filter layer may be the same or different from each other.

The micro lens layer MLL may be arranged on the infrared filter IRCF. The micro lens layer MLL may include a plurality of micro lenses ML. The micro lens layer MLL may focus light onto the pixel array PXA. Each of the plurality of pixels PX included in the pixel array PXA may detect light of a specific spectral region from light received through the micro lens layer MLL. In one or more embodiments, a region other than the micro lens ML in the micro lens layer MLL may include SiO₂, air, siloxane-based spin on glass (SOG), etc. However, the disclosure is not necessarily limited thereto.

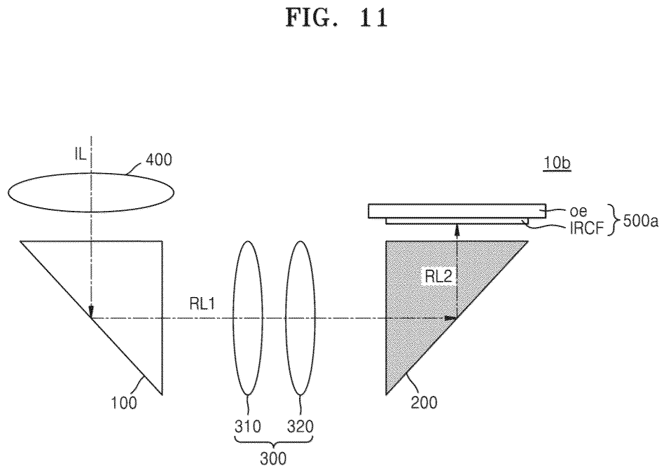

FIG. 11 is a diagram showing the camera module 10b including an on-chip infrared filter image sensor according to one or more embodiments. FIG. 11 illustrates a case when the image sensor 500a is an on-chip infrared filter image sensor. Descriptions already given above are omitted.

Referring to FIG. 11, the second reflective member 200 may be an infrared prism irpz. In one or more embodiments, at least one of the first reflective member 100 and the second reflective member 200 may include an infrared cut material, and the image sensor 500a may be an on-chip infrared filter image sensor. For example, the second reflective member 200 may be an infrared prism irp including an infrared cut material, and the first reflective member 100 may be a normal prism (e.g., the normal prism npz of FIG. 2A) that does not include an infrared cut material. For example, the second reflective member 200 may uniformly include an infrared cut material throughout, and the second reflective member 200 may absorb infrared light throughout the second reflective member 200. In FIG. 11, a case in which the second reflective member 200 is an infrared prism irpz is illustrated, but the disclosure is not necessarily limited thereto, and the first reflective member 100 may be an infrared prism irpz, and both the second reflective member 200 and the first reflective member 100 may be infrared prisms irpz.

In a configuration where the first reflective member 100 is a normal prism npz, first reflected light RL1 emitted from the first reflective member 100 may include visible light and a relatively large amount of infrared light. Because the second reflective member 200 is an infrared prism irpz, the second reflective member 200 may absorb infrared light included in the first reflected light RL1. Because the second reflective member 200 absorbs infrared light, the second reflected light RL2 may include visible light and a relatively small amount of infrared light.

The second reflected light RL2 may be transmitted to the image sensor 500a. If the second reflected light RL2 includes infrared light, the infrared light may be blocked by the infrared filter IRCF of the image sensor 500a. By using the on-chip infrared filter image sensor 500a, the camera module 10b may block more infrared light included in the incident light IL.

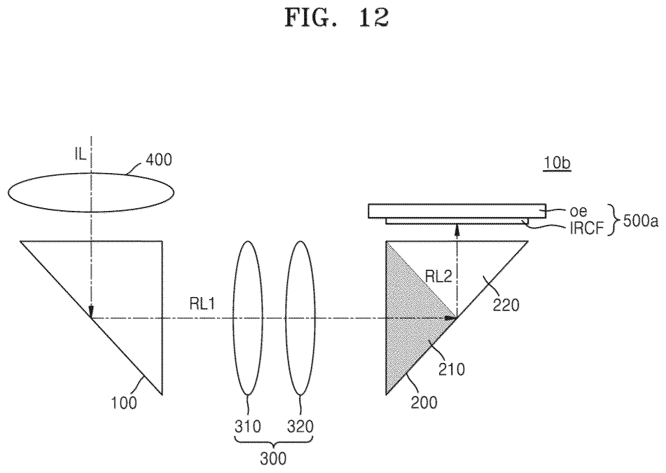

FIG. 12 is a diagram showing the camera module 10b including the on-chip infrared filter image sensor 500a according to one or more embodiments. In FIG. 12, it is assumed that a part of the second reflective member 200 includes an infrared cut material. Descriptions already given above are omitted.

Referring to FIG. 12, the second reflective member 200 may be an infrared prism irpz, and the first reflective member 100 may be a normal prism npz. In one or more embodiments, a portion of one of the first reflective member 100 and the second reflective member 200 may include an infrared cut material, and the camera module 10b may include the image sensor 500a. For example, a portion of the second reflective member 200 may include an infrared cut material. The second reflective member 200 may include an infrared region 210 and a normal region 220. In FIG. 12, an embodiment in which a portion of the second reflective member 200 includes an infrared cut material is illustrated, but the description of FIG. 12 may also be applied to an embodiment in which an embodiment in which a portion of the first reflective member 100 and the second reflective member 200 include an infrared cut material.

Because the second reflective member 200 absorbs infrared light, the second reflected light RL2 may include visible light and a relatively small amount of infrared light. The second reflected light RL2 may be transmitted to the image sensor 500a. If the second reflected light RL2 includes infrared light, the infrared light may be blocked by the infrared filter IRCF of the image sensor 500a.

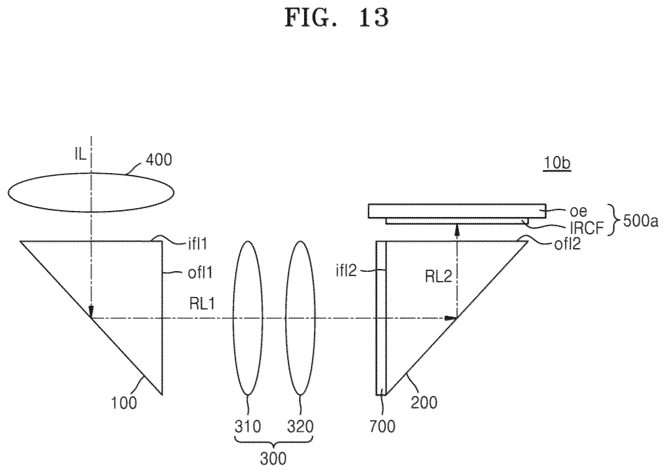

FIG. 13 is a diagram to explain the camera module 10b including a coating layer according to one or more embodiments. In FIG. 13, it is assumed that the camera module 10b includes the coating layer 700 disposed on at least a portion of the second reflective member 200 and the on-chip infrared filter image sensor 500a. Descriptions already given above are omitted.

In one or more embodiments, the camera module 10b may include a coating layer disposed on the outside of at least one of the first reflective member 100 and the second reflective member 200. For example, the coating layer 700 may be disposed on the outside of the second reflective member 200. However, the disclosure is not necessarily limited thereto, and the coating layer 700 may be disposed on the outside of the first reflective member 100, or may be disposed on the outside of the first reflective member 100 and the second reflective member 200.

The coating layer 700 may be arranged to contact at least one of an incident surface and an exit surface of the reflective member. For example, the first reflective member 100 may include a first incident surface ifl1 on which incident light IL is incident and a first exit surface ofl1 on which the first reflected light R11 is reflected, and the second reflective member 200 may include a second incident surface ifl12 on which the first reflected light R11 is incident and a second exit surface ofl2 on which the second reflected light RL2 is emitted. In one or more embodiments, the coating layer 700 may be arranged to contact at least one of the first incident surface ifl1, the first exit surface of11, the second incident surface ifl12, and the second exit surface ofl2. For example, the coating layer 700 may be arranged to contact the second incident surface ifl2. However, the disclosure is not necessarily limited thereto, and the coating layer 700 may be arranged in various ways.

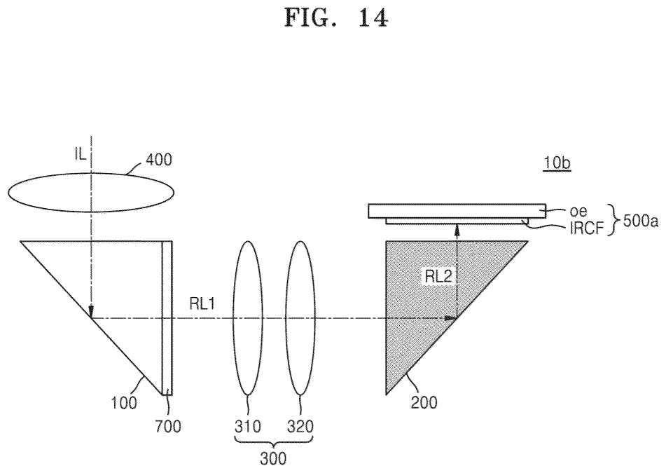

FIG. 14 is a diagram to explain the camera module 10b including an infrared prism and a coating layer according to an exemplary embodiment of the present disclosure. In FIG. 14, it is assumed that the camera module 10b includes the second reflective member 200 which is an infrared prism, the coating layer 700, and the on-chip infrared filter image sensor 500a. Descriptions already given above are omitted.

In one or more embodiments, the camera module 10b includes the on-chip infrared filter image sensor 500a and the coating layer 700 arranged on the outside of at least one of the first reflective member 100 and the second reflective member 200, and at least one of the first reflective member 100 and the second reflective member 200 may be an infrared prism. For example, the coating layer 700 may be disposed outside the first reflective member 100, and the second reflective member 200 may be an infrared prism irpz. However, the disclosure is not necessarily limited thereto. The camera module 10b may include the on-chip infrared filter image sensor 500a, the coating layer 700, and the infrared prism irpz, thereby improving infrared light cut performance.

FIG. 15 is a front perspective view of an electronic device 800 according to one or more embodiments. FIG. 16 is a rear perspective view of the electronic device 800 according to one or more embodiments.

Referring to FIGS. 15 and 16, the electronic device 800 according to one or more embodiments may include a housing 810 including a first surface (or a front surface) 810A, a second surface (or a rear surface) 810B, and a third surface (or a side surface) 810C surrounding a space between the first surface 810A and the second surface 810B. The housing 810 may also refer to a structure forming a portion of the first surface 810A, the second surface 810B, and the third surface 810C. The camera module 10 described with reference to FIGS. 1 to 14 may be applied to camera modules 805 and 812 of the electronic device 800.

The first surface 810A may be formed by a front plate 802 (e.g., a glass plate including various coating layers or a polymer plate) that is at least partially substantially transparent. The second surface 810B may be formed by a substantially opaque rear plate 811. The rear plate 811 may be formed by, for example, coated or colored glass, ceramic, polymer, a metal (e.g., aluminum, stainless steel (STS), or magnesium), or any combination of at least two of the above materials. The third surface 810C is coupled with the front plate 802 and the rear plate 811 and may be formed by a side bezel structure (or a side member) 818 including a metal and/or polymer.

The rear plate 811 and the side bezel structure 818 may be formed integrally and may include the same material (e.g., a metal material such as aluminum).

The rear plate 811 may include two second regions 810E that are bent and seamlessly extended towards the front plate 802 from a portion of the second surface 810B. The second regions 810E may be included at both ends of the long edge of the rear plate 811.

The front plate 802 (or the rear plate 811) may include only one of the first regions 810D (or the second regions 810E). In another embodiment, the front plate 802 (or the rear plate 811) may not include some of the first regions 810D (or the second regions 810E).

The side bezel structure 818 may have a first thickness (or width) in a side direction (e.g., a short side) that does not include the first regions 810D or the second regions 810E as described above, when viewed from the side of the electronic device 800, and may have a second thickness that is less than the first thickness in a side direction (e.g., a long side) that includes the first regions 810D or the second regions 810E.

A display 801 may be visually exposed through a significant portion of the front plate 802. For example, at least a portion of the display 801 may be visually exposed through the front plate 802 including the first region 810D of the first surface 810A and the third surface 810C. The display 801 may be arranged on a rear surface of the front plate 802.

An audio module may include a microphone hole 803 and a speaker hole 807.

The electronic device 800 may include a first camera module 805 (e.g., a punch hole camera) exposed at the first surface 810A of the electronic device 800 and a second camera module 812 exposed at the second surface 810B.

The first camera module 805 may be visually exposed through a portion of screen display regions 810A and 810D, that is, the first surface 810A and the second region 810D of the display 801. For example, the first camera module 805 may be visually exposed at a portion of the screen display regions 810A and 810D, that is, the first surface 810A and the second region 810D, through an opening formed in a portion of the display 801. In another example, the first camera module 805 (e.g., an under-display camera) may be placed on a rear of the display 801 and may not be visually exposed at the screen display regions 810A and 810D, that is, the first surface 810A and the second region 810D.

The second camera module 812 may include multiple cameras (e.g., dual cameras, triple cameras, or quad cameras). However, the second camera module 812 is not necessarily limited to including multiple cameras and may include one camera. For example, at least a portion of the first camera module 805 and the second camera module 812 may protrude outside the electronic device 800, and the protruding portion of the first camera module 805 and the second camera module 812 may be covered with a cover window CW. For example, the portion of the second camera module 812 that protrudes outside the electronic device 800 may be covered with the cover window CW. The cover window CW may be a part of the rear surface 810B and may be coupled to the rear surface 810B. When viewing the rear surface 810B of the electronic device 800 from the outside, a portion of the second camera module 812 that protrudes outward through the cover window CW may not be visible.

The first camera module 805 and the second camera module 812 may include one or more lenses, image sensors, and/or image signal processors. In one or more embodiments, two or more lenses (e.g., an infrared camera, wide-angle and telephoto lenses, etc.) and image sensors may be arranged on one surface of the electronic device 800. In addition, the first camera module 805 and the second camera module 812 may be configured to have different angles of view. For example, the first camera module 805 may be configured to have a narrow angle of view, and the second camera module 812 may be configured to have a wide angle of view. By designing the angles of view of the plurality of camera modules differently, images of an object (i.e., a subject) may be captured at various depths, and a zoom function may be implemented. In addition, a high zoom ratio may be implemented without increasing the thickness of the electronic device 800.

In one or more embodiments, the second camera module 812 may have a double-folded structure, as illustrated in FIG. 1. For example, the second camera module 812 may include an infrared prism (for example, the infrared prism irpz of FIG. 3). For example, the second camera module 812 may include an on-chip infrared filter image sensor (for example, the image sensor 500a of FIG. 9). In the second camera module 812, a separate infrared cut filter that absorbs incident infrared light may be omitted, and thus, a portion of the second camera module 812 protruding outside the electronic device may be reduced, and a portion of the cover window CW protruding from the rear surface 810B may be reduced. Accordingly, user convenience and aesthetics may be increased.

A key input device (817) may be arranged on the third surface 810C of the housing 810 (e.g., the first regions 810D and/or the second regions 810E). A connector hole 808 may accommodate a connector. The connector hole 808 may be arranged on the third surface 810C of the housing 810.

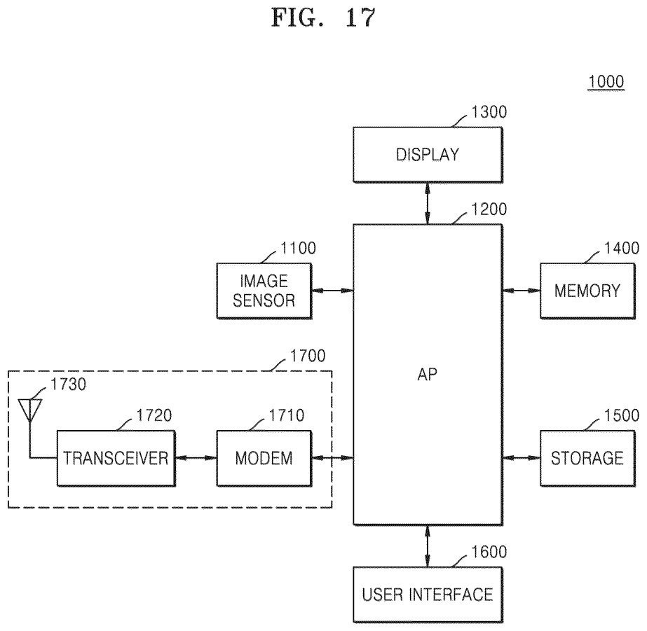

FIG. 17 is a block diagram illustrating an electronic device 1000 according to one or more embodiments. For example, the electronic device 1000 may be a portable terminal.

Referring to FIG. 17, the electronic device 1000 according to one or more embodiments may include an application processor AP 1200, an image sensor 1100, a display device 1300, a memory 1400, a storage 1500, a user interface 1600, and a wireless transceiver 1700.

The electronic device 1000 may include at least one camera module. The description of the camera module according to the embodiments described with reference to FIGS. 1 to 14 may be applied to the electronic device 1000. The camera module may perform an infrared cut function even without including a separate infrared cut filter. In one or more embodiments, the camera module may include an infrared prism (for example, the infrared prism irpz of FIG. 3). In one or more embodiments, the second camera module 812 may include an on-chip infrared filter image sensor (e.g., the image sensor 500a of FIG. 9). Because a separate infrared cut filter may be omitted from the camera module, a portion of the camera module protruding outside the electronic device 1000 may be reduced.

The application processor 1200 may be provided as a system on chip SoC that controls an overall operation of the electronic device 1000 and drives an application program, an operating system, etc.

The application processor 1200 may receive output data from the image sensor 1100.

The image sensor 1100 may generate image data based on a received optical signal and provide the image data to the application processor 1200. For example, the image sensor 1100 may be an on-chip infrared filter image sensor.

The memory 1400 may be implemented as a resistive memory such as a volatile memory, such as DRAM, SRAM, etc. or a nonvolatile resistive memory, such as FeRAM, RRAM, PRAM, etc. The memory 1400 may store programs and/or data that are processed or executed by the application processor 1200.

The storage 1500 may be implemented as a nonvolatile memory device, such as NAND flash, resistive memory, etc., and for example, the storage 1500 may be provided as a memory card (MMC, eMMC, SD, micro SD), etc. The storage (1500) may store data and/or programs for executing algorithms that control the image processing operation of the image sensor 1100, and when the image processing operation is performed, the data and/or programs may be loaded into the memory 1400.

The user interface 1600 may be implemented as various devices capable of receiving user input, such as a keyboard, curtain key panel, touch panel, fingerprint sensor, microphone, etc. The user interface 1600 may receive user input and provide a signal corresponding to the received user input to the application processor 1200.

The wireless transceiver 1700 may include a transceiver 1720, a modem 1710, and an antenna 1730.

While the disclosure has been particularly shown and described with reference to embodiments thereof, it will be understood that various changes in form and details may be made therein without departing from the spirit and scope of the following claims.

What is claimed is:

1. An optical assembly comprising:
a first reflective member configured to reflect light, received in a first direction, in a second direction intersecting the first direction;
a second reflective member configured to reflect the light reflected by the first reflective member in a third direction and onto an image sensor, wherein the third direction intersects the second direction; and
a first lens group between the first reflective member and the second reflective member in the second direction, the first lens group comprising at least one lens,
wherein at least a portion of at least one of the first reflective member and the second reflective member comprises an infrared cut material configured to absorb at least a portion of an infrared portion of the light.

2. The optical assembly of claim 1, wherein the infrared cut material comprises blue glass.

3. The optical assembly of claim 1,
wherein one of the first reflective member and the second reflective member consists entirely of the infrared cut material, and
wherein the other reflective member from among the first and the second reflective members comprises the infrared cut material and a material other than the infrared cut material.

4. The optical assembly of claim 1,
wherein at least a portion of each of the first reflective member and the second reflective member comprises the infrared cut material, and
wherein an infrared wavelength range absorbed by the first reflective member is different from an infrared wavelength range absorbed by the second reflective member.

5. The optical assembly of claim 1, further comprising:
a coating layer on an exterior of at least one of the first reflective member and the second reflective member,
wherein the coating layer is configured to absorb at least a portion of the infrared portion of the light.

6. The optical assembly of claim 5,
wherein the at least one of the first reflective member and the second reflective member comprises an incident surface through which light is incident on the reflective member and an exit surface through which light reflected by the reflective member is emitted, and
wherein the coating layer is in contact with at least one of the incident surface and the exit surface.

7. The optical assembly of claim 1,
wherein the second reflective member comprises an exit surface from which the light reflected in the third direction is emitted, and
wherein a distance from the exit surface of the second reflective member to the image sensor is 0.5 mm or less.

8. The optical assembly of claim 1,
wherein the optical assembly comprises the image sensor, and
wherein the image sensor comprises an infrared filter configured to absorb at least a portion of the infrared portion of the light reflected onto the image sensor.

9. The optical assembly of claim 1, further comprising a second lens group configured to focus the light on the first reflective member, the second lens group comprising at least one lens.

10. A camera module comprising:
a first reflective member configured to reflect light, received in a first direction, in a second direction perpendicular to the first direction;
a second reflective member configured to reflect the light reflected by the first reflective member in a third direction perpendicular to the second direction; and
an image sensor configured to convert into an electrical signal the light reflected by the second reflective member,
wherein the image sensor comprises an infrared filter configured to absorb at least a portion of an infrared portion of the light.

11. The camera module of claim 10,
wherein the image sensor further comprises:
a pixel array comprising a plurality of pixels; and
a color filter above the pixel array, and
wherein the infrared filter is above the color filter.

12. The camera module of claim 10, wherein at least one of the first reflective member and the second reflective member uniformly comprises an infrared cut material.

13. The camera module of claim 12, wherein the infrared cut material comprises blue glass.

14. The camera module of claim 10, further comprising:
a coating layer on an exterior of at least one of the first reflective member and the second reflective member,
wherein the coating layer is configured to absorb at least a portion of the infrared portion of the light.

15. The camera module of claim 14,
wherein the first reflective member comprises a first incident surface through which light is incident on the first reflective member and a first exit surface through which light reflected by the first reflective member is emitted,
wherein the second reflective member comprises a second incident surface through which light is incident on the second reflective member and a second exit surface through which light reflected by the second reflective member is emitted, and
wherein the coating layer is on at least one of the first incident surface, the first exit surface, the second incident surface, and the second exit surface.

16. The camera module of claim 10, further comprising:
a first lens group comprising at least one lens,
wherein the first lens group is between the first reflective member and the second reflective member in the second direction and is configured to focus the light reflected by the first reflective member in the second direction onto the second reflective member.

17. The camera module of claim 10,
wherein the second reflective member comprises a second exit surface through which light reflected by the second reflective member is emitted, and
wherein a distance from the second exit surface to the image sensor is 0.5 mm or less.

18. A camera module comprising:
a first reflective member configured to reflect light, received in a first direction, in a second direction perpendicular to the first direction;
a second reflective member configured to reflect the light reflected by the first reflective member in a third direction perpendicular to the second direction; and
an image sensor configured to convert into an electrical signal the light reflected by the second reflective member,
wherein at least one of the first reflective member and the second reflective member uniformly comprises an infrared cut material, and
wherein the infrared cut material is configured to absorb at least a portion of an infrared portion of the light.

19. The camera module of claim 18, wherein the image sensor comprises an infrared filter configured to absorb at least a portion of the infrared portion of the light reflected onto the image sensor.

20. The camera module of claim 18,
wherein one of the first reflective member and the second reflective member uniformly comprises the infrared cut material, and
wherein the other reflective member from among the first and the second reflective members is adjacent to a coating layer configured to absorb at least a portion of the infrared portion of the light.
